(19) United States
(12) Patent Application Publication
(10) Pub. No.: US 2024/0163922 A1
(43) Pub. Date: May 16, 2024

(54) LATENCY-SENSITIVE TRAFFIC TRANSMISSION

(71) Applicant: NXP USA, Inc., Austin, TX (US)

(72) Inventors: Kiseon Ryu, San Diego, CA (US); Liwen Chu, San Ramon, CA (US); Hongyuan Zhang, Fremont, CA (US); Huizhao Wang, San Jose, CA (US)

(21) Appl. No.: 18/490,276

(22) Filed: Oct. 19, 2023

Related U.S. Application Data
(60) Provisional application No. 63/383,124, filed on Nov. 10, 2022.
(60) Provisional application No. 63/485,943, filed on Feb. 20, 2023.

(51) Int. Cl. H04W 74/08

(52) U.S. Cl. CPC H04W 74/0808; H04W 84/12

(57) ABSTRACT

One example discloses a method of latency-sensitive traffic transmission for communications between a first WLAN (wireless local area network) device and a second WLAN device, including: scheduling, by the first WLAN device a set of low latency (LL) traffic stream windows with the second WLAN device; having LL traffic for transmission during at least one of the LL traffic stream windows; pre-empting, by the first WLAN device, a TXOP (transmission opportunity) of the second WLAN device if the at least one of the LL traffic stream windows overlaps with the second WLAN device's TXOP; and transmitting, by the first WLAN device, the LL traffic during the TXOP of the second WLAN device that was pre-empted.

### REFERENCE TO PROVISIONAL APPLICATION TO CLAIM PRIORITY

A priority date for this present U.S. patent application has been established by prior U.S. Provisional Patent Application, Ser. No. 63/383,124, entitled “TXOP Preemption for Low Latency Traffic_Follow-up”, filed on Nov. 10, 2022, and commonly assigned to NXP USA, Inc, and to U.S. Provisional Patent Application, Ser. No. 63/485,943, entitled “Activation Of Preemption Operation”, filed on Feb. 20, 2023, and commonly assigned to NXP USA, Inc.

The present specification relates to systems, methods, apparatuses, devices, articles of manufacture and instructions for latency-sensitive traffic transmission.

### SUMMARY

According to an example embodiment, a method of latency-sensitive traffic transmission for communications between a first WLAN (wireless local area network) device and a second WLAN device, comprising: scheduling, by the first WLAN device a set of low latency (LL) traffic stream windows with the second WLAN device; having LL traffic for transmission during at least one of the LL traffic stream windows; pre-empting, by the first WLAN device, a TXOP (transmission opportunity) of the second WLAN device if the at least one of the LL traffic stream windows overlaps with the second WLAN device's TXOP; and transmitting, by the first WLAN device, the LL traffic during the TXOP of the second WLAN device that was pre-empted.

In another example embodiment, the first WLAN device is an AP and the second WLAN device is a non-AP STA (station).

In another example embodiment, the low latency (LL) traffic stream is created using a stream classification service (SCS) procedure that includes exchanging an SCS request frame and an SCS response frame.

In another example embodiment, the SCS procedure includes a quality of service characteristics element.

In another example embodiment, the SCS request frame or the SCS response frame includes at least one of: an indication of preemption operation, a SCSID, a TID, or LL traffic transmission direction information.

In another example embodiment, either the first or second WLAN devices are only allowed to transmit LL traffic associated with a particular TID or a particular SCSID.

In another example embodiment, the SCS request frame and/or the SCS response frame includes at least one of: a maximum length of a PPDU in the LL traffic; a maximum preemption duration within the TXOP; a periodicity of the the LL traffic stream windows; or a R-TWT SP overriding indication of whether or not preemption is allowed during an R-TWT service period.

In another example embodiment, the low latency (LL) traffic stream schedule is periodic or aperiodic.

In another example embodiment, the low latency (LL) traffic stream includes uplink (UL) traffic sent by the non-AP STA to the AP, downlink (DL) traffic sent by the AP to the non-AP STA, or direct link traffic sent between the non-AP STA and another non-AP STA.

In another example embodiment, further comprising: allocating a non-random access resource unit (non-RA-RU) to the non-AP STA using a trigger frame; wherein the non-RA-RU enables the non-AP STA to transmit UL traffic.

In another example embodiment, further comprising: allocating a time period to the non-AP STA using a multi-user (MU) request-to-send (RTS) TXOP sharing (TXS) trigger frame; wherein the MU-RTS-TXS trigger frame enables the non-AP STA to transmit UL traffic or direct-link traffic.

In another example embodiment, further comprising, preempting, by the AP, the TXOP of the non-AP STA during a target wake time service period (TWT SP).

In another example embodiment, the TWT SP may be either an individual TWT SP, a broadcast TWT SP, or a R-TWT SP.

In another example embodiment, pre-empting the TXOP is enabled by giving a higher scheduling priority to the low latency (LL) traffic transmissions, than to TWT requesting STAs transmissions or TWT scheduled STAs transmissions during the TWT SP.

In another example embodiment, the TXOP holder preemption during the TWT SP may be enabled or disabled as part of a negotiated TWT agreement established between a TWT requesting STA (or a TWT scheduled STA) and a TWT responding STA (or a TWT scheduling AP).

In another example embodiment, the TXOP holder preemption during the TWT SP may alternatively be enabled or disabled when a TWT scheduling AP announces TWT SP scheduling information.

In another example embodiment, further comprising: announcing, by the AP, a TXOP preemption time period information in a broadcast management or action frame.

In another example embodiment, the announcement informs various non-AP STAs that a set of LL traffic pre-emption time periods have been defined; and the announcement informs the various non-AP STAs that any non-AP STA holding a TXOP during a time overlapping any one of these time periods may have their traffic pre-empted.

In another example embodiment, the AP transmits the announcement in either a broadcast management frame, an action frame, or a beacon frame.

In another example embodiment, further comprising: receiving, by the AP from the non-AP STA, an RTS (request to send) frame; transmitting, by the AP to the non-AP STA, a TXOP preemption request frame instead of a CTS (clear to send) frame; wherein the TXOP preemption request frame blocks the non-AP STA from obtaining the TXOP; and scheduling, by the AP, transmission of the LL traffic.

In another example embodiment, the TXOP preemption functionality is indicated in a UHR operation or a UHR capabilities element during an association procedure between the WLAN devices.

In another example embodiment, the UHR element includes bits indicating the WLAN device's LL traffic pre-emption capability and whether permission to use such capability has been granted.

In another example embodiment, the AP grants permission to the non-AP STA to transmit the LL traffic within a TXOP not held by the non-AP STA; and the non-AP STA is neither a current TXOP holder nor a current TXOP responder.

In another example embodiment, the AP is granted permission to transmit the LL traffic as a current TXOP responder and the AP is not a current TXOP holder.

According to an example embodiment, a WLAN (wireless local area network) access point (AP) device, comprising: a controller configured to, schedule a set of low latency (LL) traffic stream windows with a non-AP STA (station); and pre-empt a TXOP (transmission opportunity) of the non-AP STA for LL traffic uplink (UL), downlink (DL), or direct-link transmission during at least one of the LL traffic stream windows, if the at least one of the LL traffic stream windows overlaps with the non-AP STA's TXOP.

In another example embodiment, the AP activates the TXOP preemption functionality after transmitting or receiving a frame indicating TXOP preemption activation.

In another example embodiment, the frame indicating TXOP preemption activation is at least one of a separate control frame or an action frame.

In another example embodiment, the frame indicating TXOP preemption activation is a QoS null frame including an UHR variant HT control field.

In another example embodiment, the AP activates the TXOP preemption functionality in response to the non-AP STA transmitting a request frame for activation of the TXOP preemption functionality.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a first example wireless communications network (WLAN).

FIG. 2 represents an example response to latency-sensitive traffic (i.e. LS frame to STA2).

FIG. 3 represents an example protocol for TXOP preemption notification for downlink (DL) low latency (LL) traffic transmission.

FIG. 4 represents an example protocol for TXOP preemption notification for uplink (UL) low latency (LL) traffic transmission.

FIGS. 5A and 5B represent examples for an AP to allocate uplink (UL) resources using a trigger frame for random access so that a non-AP STA can transmit a low latency data frame using the allocated random-access resource units.

FIG. 6 represents an example stream classification service (SCS) procedure to enable low latency (LL) traffic transmissions.

FIG. 7 represents an example of pre-empting a TXOP held by a non-AP STA (e.g. STA1 or STA2) during a TWT SP (target wake time service period) to enable low latency (LL) traffic transmissions.

FIG. 8 represents an example AP announcement to enable low latency (LL) traffic transmissions.

FIG. 9 represents an example to enable low latency (LL) traffic transmissions in response to an RTS (request to send) frame received from a non-AP STA.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

IEEE (Institute of Electrical and Electronics Engineers) 802 defines communications standards for various networked devices (e.g., Local Area Networks (LAN), Metropolitan Area Networks (MAN), etc.). IEEE 802.11 further defines communications standards for Wireless Local Area Networks (WLAN). As such, communications on these networks must, by agreement, follow one or more communications protocols (i.e. be standards compliant) so that various network devices can communicate. These protocols are not static and are modified (e.g., different generations) over time, typically to improve communications robustness and increase throughput.

In embodiments of a wireless communication network described below, a wireless communications device such as an access point (AP) of a wireless local area network (WLAN) transmits data streams to one or more client stations (STAs). The AP and STAs communicate using one or more communication protocols. These protocols may include IEEE protocols such as: 802.11b; 802.11g; 802.11a; 802.11n [i.e. HT (High Throughput) with Single-User Multiple-Input Multiple-Output (SU-MIMO)]; 802.11ac [i.e. VHT (Very High Throughput) with downlink Multi-User MIMO (MU-MIMO)]; 802.11ax [i.e. HE (High Efficiency) operating at both 2.4- and 5-GHz bands, including OFDMA (Orthogonal Frequency Division Multiple Access) and MU-MIMO with uplink scheduling]; and 802.11be [i.e. EHT (Extra High Throughput) operating at 2.4 GHz, 5 GHz, and 6 GHz frequency bands and a much wider 320 MHz bandwidth].

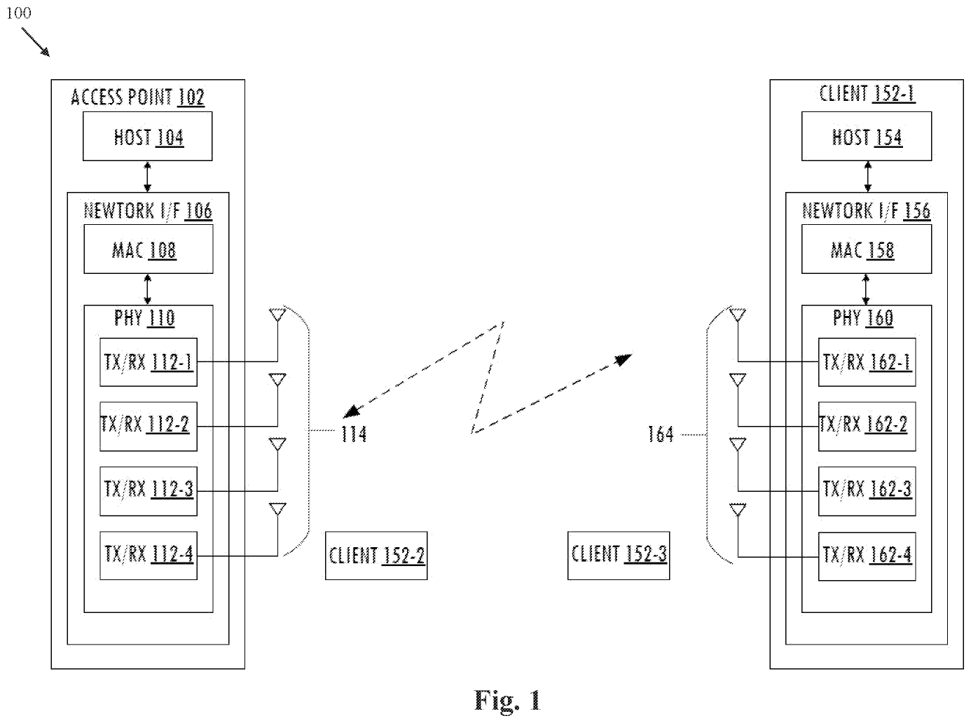

FIG. 1 represents a first example 100 wireless communications network (WLAN) formed by a first set of wireless communications devices (i.e. AP STAs and Client-STAs). The WLAN 100 includes access point station (AP STA) 102 and a set of non-AP stations (non-AP/Client STAs) 152-1, 152-2, and 152-3.

The AP 102 includes host processor 104 (e.g., controller) coupled to network interface 106. Host processor 104 includes a processor configured to execute machine readable instructions stored in a memory device (not shown), e.g., random access memory (RAM), read-only memory (ROM), a flash memory, or other storage device.

Network interface 106 includes medium access control (MAC) processor 108 and physical layer (PHY) processor 110. In some example embodiments the MAC processor 108 operates at the data-link layer of the OSI (Open Systems Interconnection) model and the PHY processor 110 operates at the physical layer of the OSI model.

The PHY processor 110 includes a plurality of transceivers 112-1, 112-2, 112-3, and 112-4, each of which is coupled to a corresponding antenna of antennas 114. These antennas 114 can support MIMO functionality. Each of transceivers 112-1, 112-2, 112-3, and 112-4 includes a transmitter signal path and a receiver signal path, e.g., mixed-signal circuits, analog circuits, and digital signal processing circuits for implementing radio frequency and digital baseband functionality. The PHY processor 110 may also include an amplifier (e.g., low noise amplifier or power amplifier), a data converter, and circuits that perform discrete Fourier transform (DFT), inverse discrete Fourier transform (IDFT), modulation, and demodulation, thereby supporting OFDMA modulation.

The client STAs 152-1, 152-2, and 152-3 each include similar circuits (e.g., host processor 154 (e.g., controller), network interface 156, MAC processor 158, PHY processor 160, transceivers 162-1, 162-2, 162-3, and 162-4, and antennas 164) that provide similar functionality to that of AP 102 but are adapted to client-side specifications.

The MAC 108, 158 and PHY 110, 160 processors within the AP 102 and STA 152-1 exchange PDUs (Protocol Data Units) and SDUs (Service Data Units) in the course of managing the wireless communications traffic. The PHY processor is configured to receive MAC layer SDUs, encapsulate the MAC SDUs into a special PDU called a PPDU (physical layer protocol data units) by adding a preamble.

The preamble (i.e. TXVECTOR, transmission vector) specifies the PPDU's transmission format (i.e. which IEEE protocol (e.g., EHT, HE, etc.) has been used to pack the SDU data payload). The PPDU preambles may include various training fields (e.g., predetermined attributes) that are used by the receiving APs or STAs to perform synchronization, gain control, estimate channel characteristics, and signal equalization. The AP 102 and STA 152-1 then exchange the PPDU formatted wireless communications signals 116.

During exchange of wireless communications traffic, either the AP STA 102 or the non-AP STAs 152-1, 152-2, 152-3 may alternate between being a transmission opportunity (TXOP) holder and a TXOP responder.

Often a TXOP holder is transmitting non-latency-sensitive traffic when latency-sensitive traffic arrives from a TXOP responder. In such a case, latency-sensitive traffic has to wait until the TXOP ends and contends the channel again, which may cause critical delay for the latency-sensitive traffic.

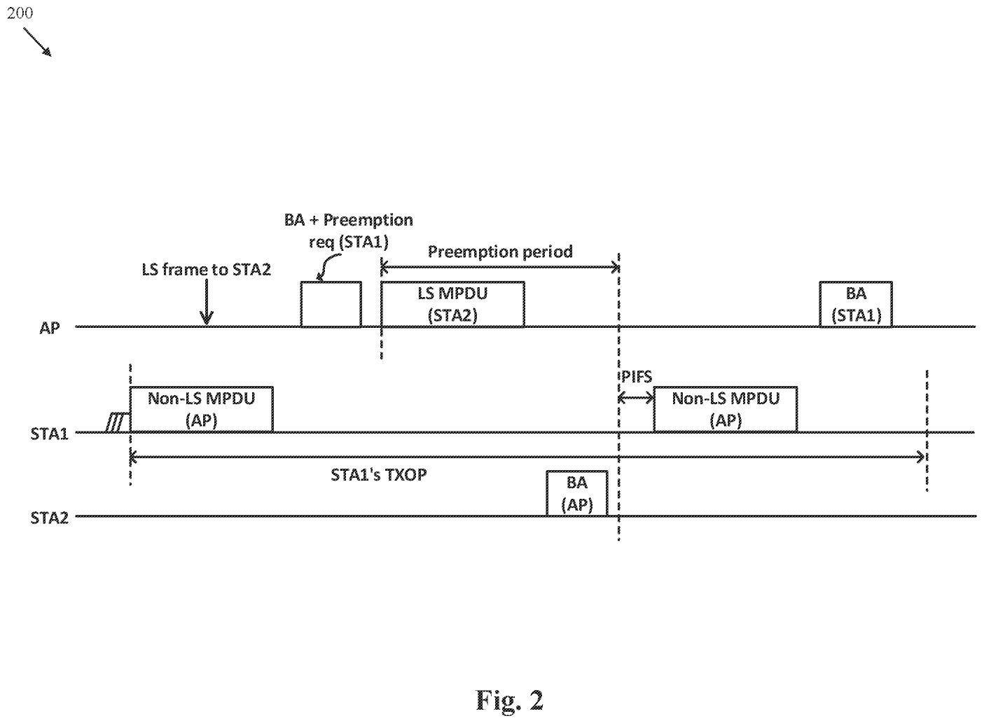

FIG. 2 represent an example 200 response to latency-sensitive traffic (i.e. LS frame to STA2). Here as shown, if a TXOP holder (e.g., a non-AP STA1) transmits a non-latency sensitive data frame to a TXOP responder (e.g., an AP) and the TXOP responder (e.g., AP) needs to transmit a latency sensitive data frame to the TXOP holder (e.g., STA1) or to other STA (e.g., STA2), the TXOP responder transmits a preemptive PPDU (i.e. LS MPDU (STA2)) to STA2. Preemption request information can be included in a control response frame such as a BlockAck frame, or a QoS Null frame including an HE-Control subfield.

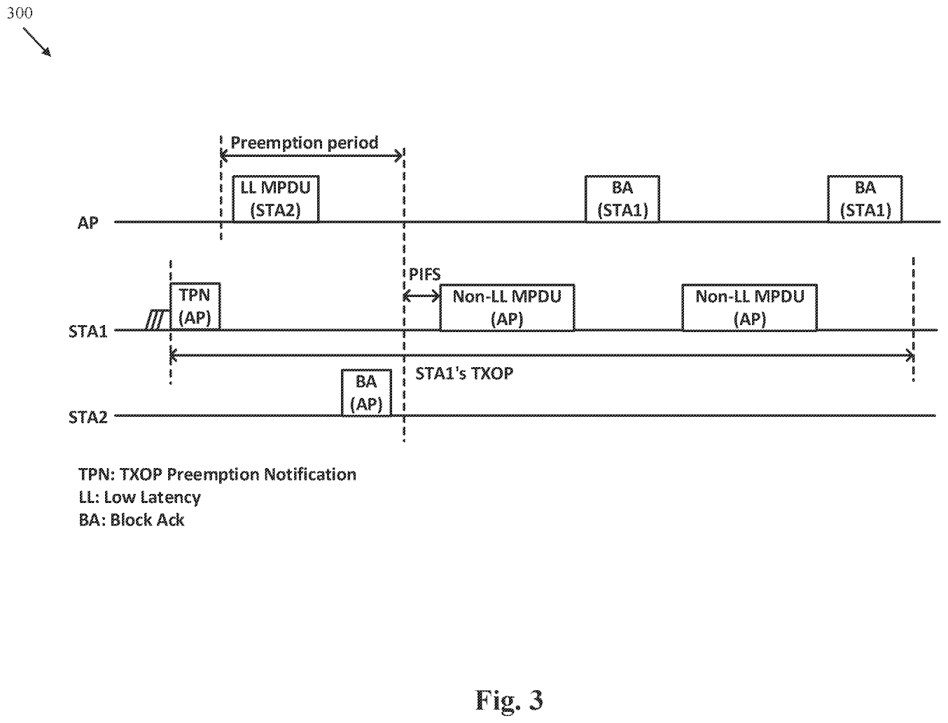

FIG. 3 represents an example 300 protocol for TXOP preemption notification for downlink (DL) low latency (LL) traffic transmission. Here a TXOP preemption period is allocated at the beginning of the TXOP by a TXOP holder (e.g., STA1) sending a TXOP Preemption Notification frame. During the allocated TXOP preemption period, an AP can transmit downlink low latency (LL) traffic to other STA (e.g., STA2). After expiry of TXOP preemption period, the TXOP holder (e.g., STA1) transmits and buffered non-low latency traffic using the remaining TXOP.

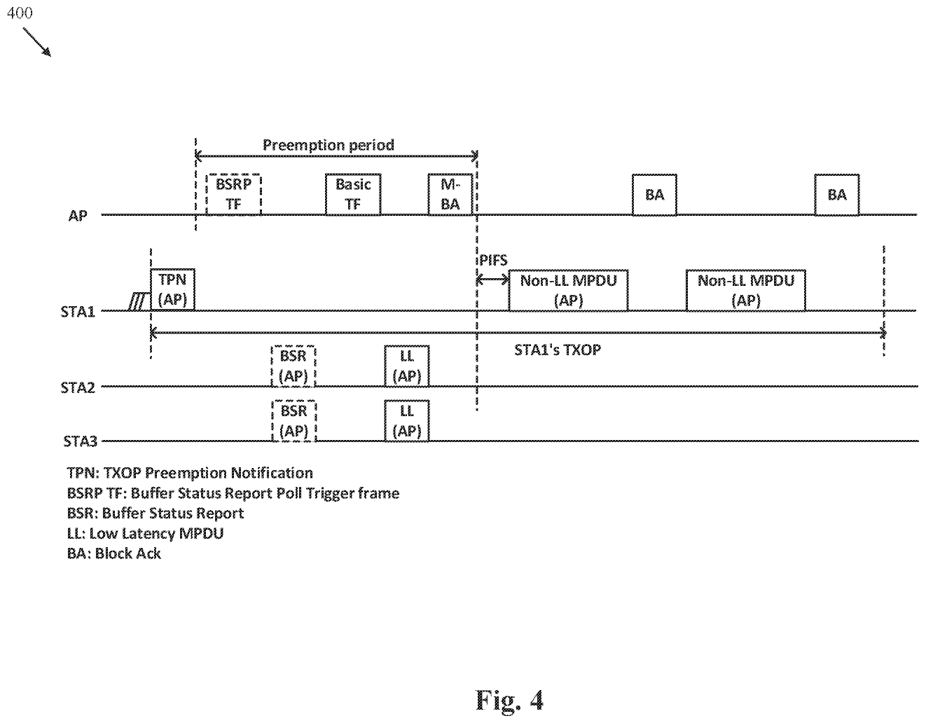

FIG. 4 represents an example 400 protocol for TXOP preemption notification for uplink (UL) low latency (LL) traffic transmission. Here again, a TXOP preemption period is allocated at the beginning of the TXOP by a TXOP holder (e.g., STA1) sending a TXOP Preemption Notification frame. During the allocated TXOP preemption period, an AP transmits one or more Trigger frame (e.g., BSRP Trigger frame, Basic Trigger frame) to other STAs (e.g., STA2 and STA3) to get STA's buffer status information regarding uplink buffered low latency traffic and/or to allocate uplink resource for the STAs (e.g., STA2 and STA3) to transmit uplink buffered low latency traffic using a trigger-based PPDU. After expiry of TXOP preemption period, the TXOP holder (e.g., STA1) transmit buffered non-low latency traffic using the remaining TXOP.

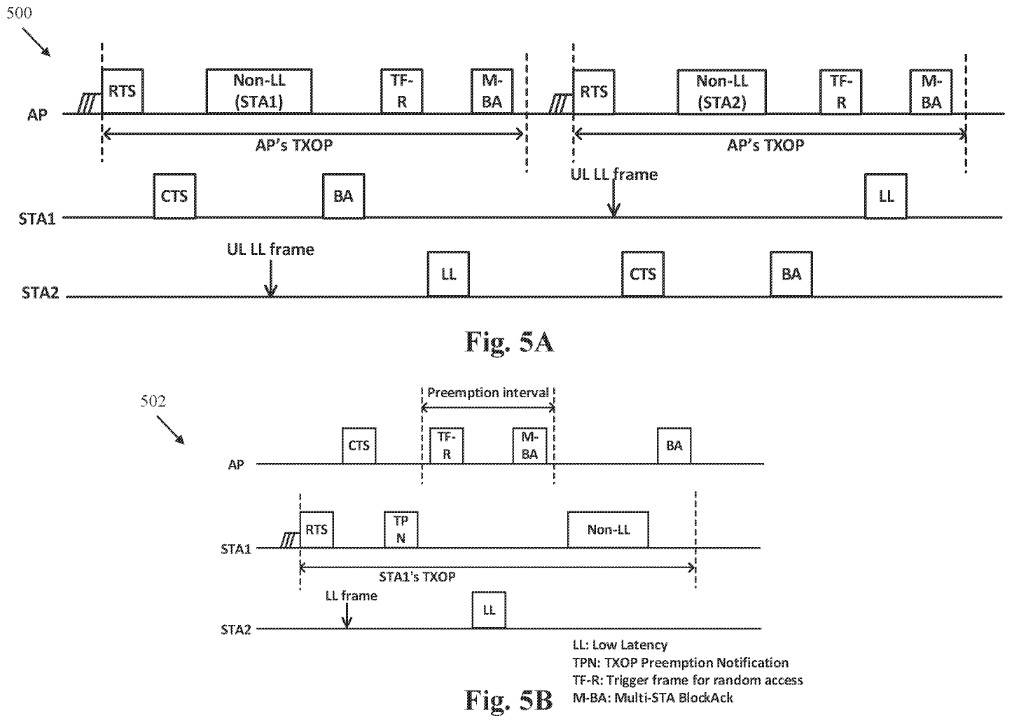

FIGS. 5A and 5B represent examples 500, 502 for an AP to allocate uplink (UL) resources using a trigger frame for random access so that a non-AP STA can transmit a low latency data frame using the allocated random-access resource units. For example, during a DL TXOP, an AP allocates using a trigger frame (TF-R) at least one or more random access resource units (RA-RUs) for non-AP STAs to transmit an uplink low latency frame or a buffer status report frame related to a buffered low latency frame using the RA-RUs. Alternately, during an UL TXOP, if an AP is granted for RDG by a TXOP holder non-AP STA or it has a transmission time period (e.g., by the TXOP preemption), the AP may allocate at least one or more RA-RUs by a trigger frame to trigger transmission of the low latency frame from other non-AP STAs.

Using a stream classification service (SCS) procedure in IEEE 802.11be for low-latency traffic scheduling is not as easy as might be expected. For example, a non-AP EHT STA may transmit an SCS Request frame with SCS Descriptor element(s) containing a QoS Characteristics element if the Request Type field in the frame is set to “Add” or “Change”. The QoS Characteristics element describes the traffic characteristics of the requested SCS stream. The QoS Characteristics element is a reference for the EHT AP's scheduling.

An EHT AP schedules transmission of downlink frames such that the delay bound and minimum data rate requested are met for the downlink Data frames if a direction subfield (e.g. UL, DL, or direct-link information) of the QoS Characteristics element indicates downlink. An EHT AP enables the transmission of uplink frames from the EHT STA with an interval that falls between the requested minimum and maximum service intervals and the AP should meet the minimum data rate requested if the direction subfield of the QoS Characteristics element indicates uplink.

An EHT AP enables the transmission of direct link frames from the EHT STA to another STA on the link specified in the LinkID subfield of the Control Info field with an interval that falls between the requested minimum and maximum service intervals. A QoS Characteristics element provided by a non-AP EHT STA is used by a receiving EHT AP to facilitate the creation of a schedule for contention-based channel access (EDCA) or MU operation. However, how the AP uses the information provided by the non-AP STA QoS Characteristics element is not discussed in IEEE 802.11be.

Additionally, the above examples do not address how they can coexist with existing WiFi features such as TWT or R-TWT, MU-RTS TXS for p2p communication, and periodic scheduling using the SCS procedure.

Now discussed are various example embodiments for one WLAN device to transmit low-latency (LL) traffic using TXOP (transmission opportunity) pre-emption even though another WLAN device is a TXOP holder.

At a top level, an access point (AP) first schedules (e.g. defines, establishes, negotiates, etc.) a set of low latency (LL) traffic stream windows (e.g. time periods) with a non-AP station (STA). When there is LL traffic for transmission during at least one of the LL traffic stream windows, then the AP pre-empts any TXOP (transmission opportunity) of the non-AP STA if the at least one of the LL traffic stream windows overlaps with the non-AP STA's TXOP. The AP then transmits the LL traffic during the TXOP of the non-AP STA that was pre-empted. This procedure permits UL, DL or direct-link LL traffic communications between various WLAN devices (e.g. APs or non-AP STAs).

This TXOP preemption can be performed among AP and non-AP STAs that support this functionality, which in some example embodiments can be indicated in the UHR operation/capabilities element. In various example embodiments, if a non-AP STA does not support this TXOP preemption and obtains a TXOP, the AP does not preempt the TXOP even though the AP needs to schedule transmission of UL/DL/direct-link low latency (LL) traffic during the TXOP.

Various example embodiments for implementing this TXOP preemption procedure are now discussed below.

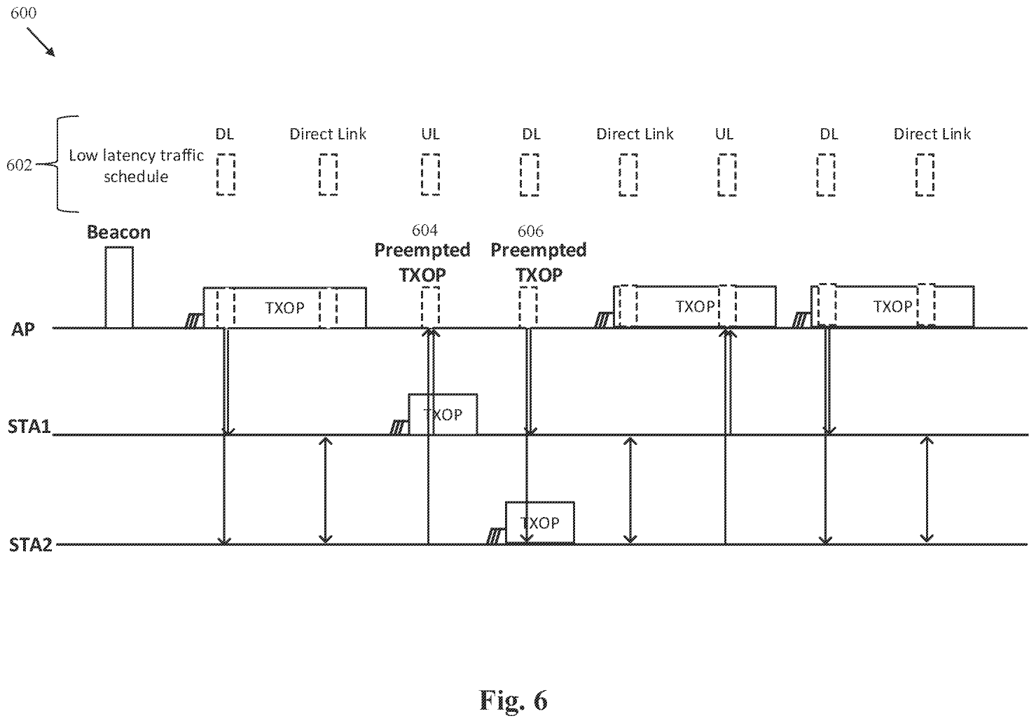

FIG. 6 represents an example 600 stream classification service (SCS) procedure for enabling low latency (LL) traffic transmissions. An AP may pre-empt a non-AP STA (e.g. STA1 or STA2) TXOP holder to schedule a periodic or an aperiodic low latency traffic stream 602 which has been established between the AP and a non-AP STA and specified in the QoS Characteristics element using a stream classification service (SCS) procedure. A pre-empted TXOP 604, 606 can be used for scheduling of transmission of UL, DL, or a direct link communication based on the established SCS stream.

For TXOP pre-emption for UL transmission, in some example embodiments a non-RA-RU can be allocated by a basic trigger frame for a non-AP STA to transmit a TB PPDU during the preempted TXOP. In alternate example embodiments, for TXOP pre-emption for UL transmission, a time period for non-TB PPDU transmission can be allocated by an MU-RTS TXS Trigger frame during the preempted TXOP. In another example embodiment a non-AP STA may transmit to an AP a preemption request frame indicating its buffered UL LL traffic by preempting the AP's TXOP and the AP may schedule the non-AP STA's transmission of the UL LL traffic if the non-AP STA and the AP have negotiated an SCS procedure for the UL LL traffic.

In some example embodiments, for TXOP pre-emption for a direct link communication a time period for non-TB PPDU transmission between non-AP STAs can be allocated by an MU-RTS TXS Trigger frame during the preempted TXOP. A pre-empted TXOP can be used for scheduling of UL/DL multi-user transmission and/or one or more time period allocation for multiple non-AP STAs.

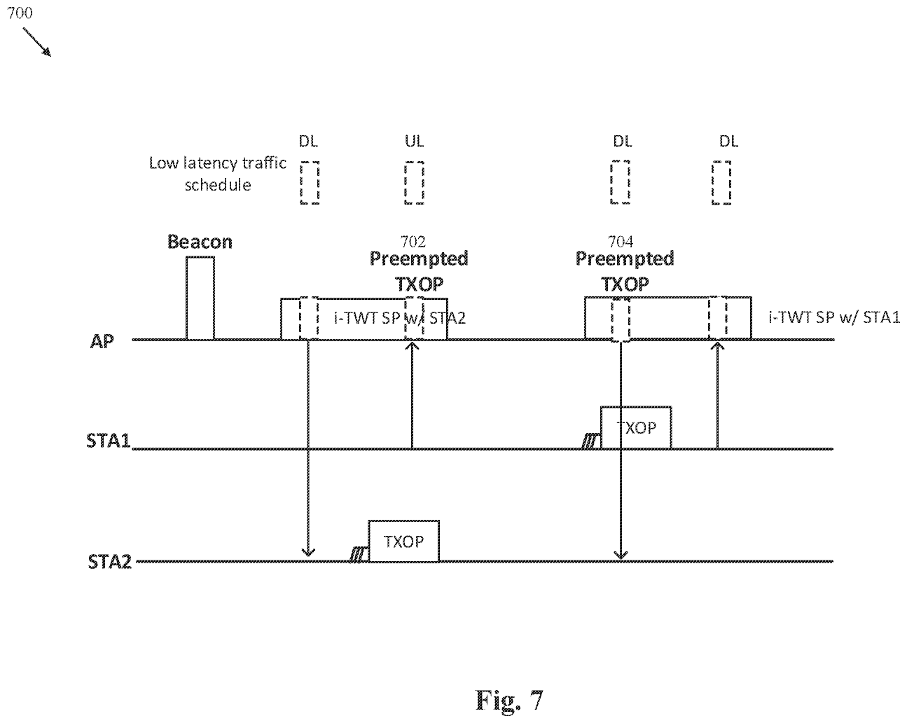

FIG. 7 represents an example 700 of pre-empting a TXOP 702, 704 held by a non-AP STA (e.g. STA1 or STA2) during a TWT SP (target wake time service period) to enable low latency (LL) traffic transmissions. The TWT SP may be either an individual TWT SP or a broadcast TWT SP. The TWT SP may in some example embodiments be a R-TWT SP.

In various example embodiments, pre-empting the TXOP is enabled by giving a higher scheduling priority to the low latency (LL) traffic transmissions, than to TWT requesting STAs transmissions or TWT scheduled STAs transmissions during the TWT SP.

In some example embodiments, the TXOP holder preemption during the TWT SP may be enabled or disabled as part of a negotiated TWT agreement established between a TWT requesting STA (or a TWT scheduled STA) and a TWT responding STA (or a TWT scheduling AP).

In other example embodiments, the TXOP holder preemption during the TWT SP may alternatively be enabled or disabled when a TWT scheduling AP announces TWT SP scheduling information.

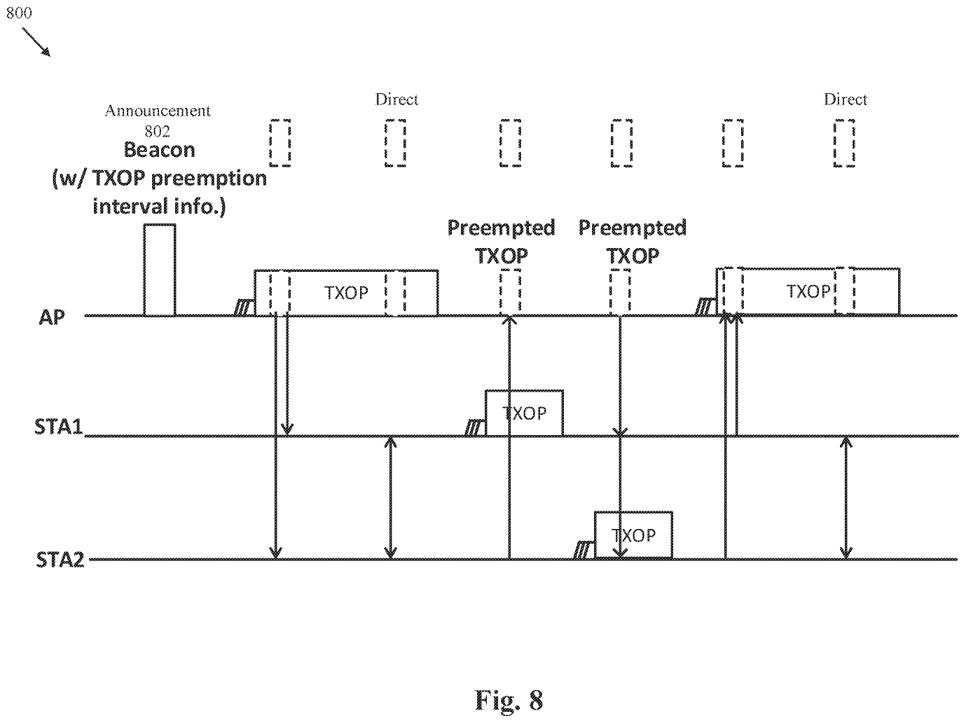

FIG. 8 represents an example 800 AP announcement 802 to enable low latency (LL) traffic transmissions. In this example 800 the AP transmits the announcement 802 in either a broadcast management frame, an action frame, or a beacon frame.

The announcement 802 informs various non-AP STAs that a set of LL traffic pre-emption time periods have been defined. The announcement 802 also informs the various non-AP STAs that any non-AP STA holding a TXOP during a time overlapping any one of these time periods may have their traffic pre-empted.

Unlike an R-TWT SP, the non-AP STA does not need to finish its transmissions before any of the time periods starts. A non-AP STA obtaining a TXOP which overlaps with the time period may need to allocate a time interval to an AP during the TXOP when the AP requests the TXOP preemption explicitly, or without AP's TXOP preemption request.

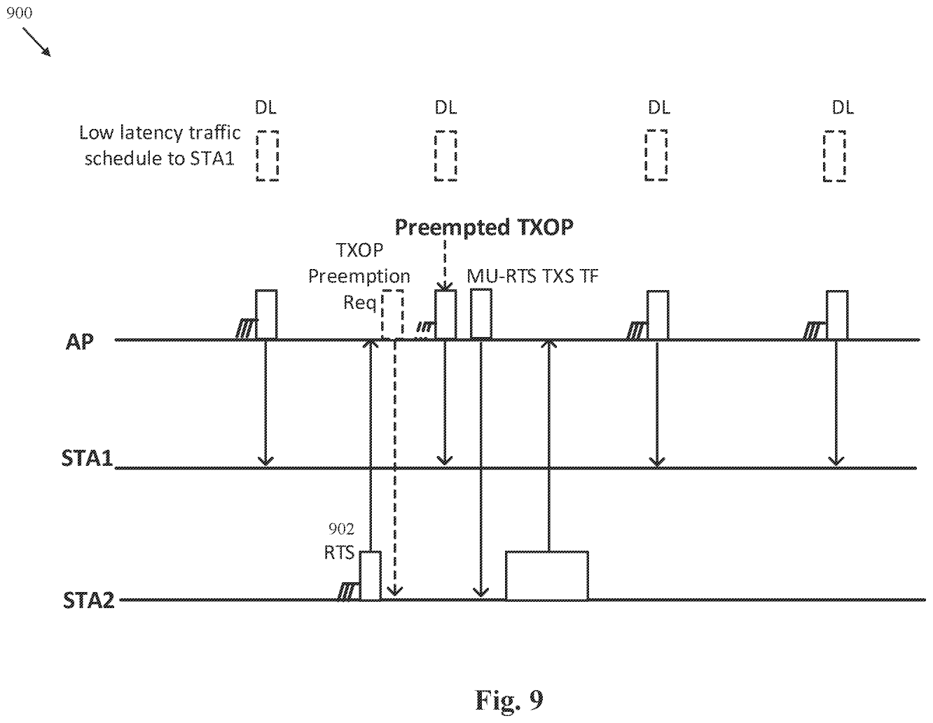

FIG. 9 represents an example 900 to enable low latency (LL) traffic transmissions in response to an RTS (request to send) frame 902 received from a non-AP STA. When the periodic low latency frame transmission is expected during a TXOP or an AP has a buffered low latency traffic.

The AP receiving an RTS frame from a non-AP STA may either transmit a TXOP preemption request frame instead of a CTS (clear to send) frame, or just not transmit a CTS frame. After the AP schedules transmission of the low latency traffic, the AP may allocate a time period to the non-AP STA such as by the CAS Control subfield of the HT Control field (e.g., RDG) or an MU-RTS TXS Trigger frame (e.g., Triggered TXOP Sharing). The AP may do this during the remaining TXOP, or during another TXOP obtained by the AP.

The AP may then perform contention-based channel access (e.g., EDCA channel access) to obtain a TXOP for scheduling of any low latency traffic after transmitting the TXOP preemption request frame or not transmitting the CTS frame.

Activation of TXOP preemption

In some example embodiments, various associated APs and non-AP STAs that have a capability for preemption (e.g. such as discussed above) may not use such preemption functionality constantly (e.g. there may be long time periods where there is no LL traffic with particular APs or non-AP STAs).

Now discussed are various procedures for activating and deactivating preemption functionality of one or more APs or non-AP STAs. Which traffic streams and/or WLAN devices that have permission to use preemption (e.g., TXOP preemption) are now defined. For example, without some form of preemption policy/rule, a non-AP STA and/or an AP might use preemption operations to transmit any frame regardless of a quality-of-service requirement of the traffic stream and thereby increasing a delay of more critical or typically expected low latency (LL) traffic.

Parameters for TXOP preemption are now defined for APs and non-AP STAs. In one example embodiment option for activation of TXOP preemption functionality a non-AP STA and an AP that has the capability of preemption operation (e.g., the preemption capability bit set to 1 in the UHR capabilities/operation element) activates TXOP preemption operation right after association procedure.

A non-AP STA and an AP that have the capability of TXOP preemption may indicate the preemption capability bit set to 1 in the Capabilities/Operation element. The AP can transmit a low latency traffic using preemption operation to the non-AP STA that sets the capability bit to true.

The AP can schedule the UL transmission for low latency traffic from the non-AP STA using preemption operation if there is an associated non-AP STA with the preemption capability bit set to 1. Otherwise, the AP does not schedule UL transmission for low latency traffic using preemption operation.

In another example embodiment option for activation of TXOP preemption functionality a non-AP STA and an AP activates TXOP preemption operation after transmitting/receiving a frame indicating activation of preemption operation. The frame can be a separate control frame or action frame other than association request/response frames including the capabilities/operation element.

The frame can be a QoS null frame including an UHR variant HT control field. A non-AP STA may transmit a request frame for activation of preemption operation to an AP, and an AP may respond with a response frame for activation of preemption operation to the non-AP STA. An AP may transmit an unsolicited response frame to a non-AP STA.

The request frame can be the SCS request frame including at least one of the indication of preemption operation, the SCSID, the TID, and the direction information (e.g., UL, DL, or Direct Link). It can be other control frame or other action frame.

The response frame can be the SCS response frame including at least one of the indication of preemption operation, the SCSID, the TID, and the direction information (e.g., UL, DL, or Direct Link). It can be other control frame or other action frame.

If the request frame and the response frame are the SCS request frame and the SCS response frame, then only TID and/or SCS ID with the indication of preemption operation field set to true can be scheduled/transmitted using preemption operation. A non-AP STA that does not have the preemption indication field set to true shall not transmit a QoS data frame associated with the TID and/or the SCS ID using preemption operation.

If preemption request information does not include preemption time period information, the TXOP responder should be able to return the preemptive TXOP to the TXOP holder after transmitting the latency sensitive frame so that the TXOP holder could use the remaining TXOP for transmission of its buffered frame. Thus after an AP or non-AP STA transmits the LL traffic successfully, a TXOP responder (e.g., AP) may indicate the TXOP preemption release to a TXOP holder through the RDG/More PPDU subfield (e.g., RDG/More PPDU subfield set to 0 can be used for indication of TXOP preemption release) in the CAS Control subfield of the HE variant HT Control field.

Various instructions and/or operational steps discussed in the above Figures can be executed in any order, unless a specific order is explicitly stated. Also, those skilled in the art will recognize that while some example sets of instructions/steps have been discussed, the material in this specification can be combined in a variety of ways to yield other examples as well, and are to be understood within a context provided by this detailed description.

In some example embodiments these instructions/steps are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A method of latency-sensitive traffic transmission for communications between a first WLAN (wireless local area network) device and a second WLAN device, comprising:
scheduling, by the first WLAN device a set of low latency (LL) traffic stream windows with the second WLAN device;
having LL traffic for transmission during at least one of the LL traffic stream windows;
pre-empting, by the first WLAN device, a TXOP (transmission opportunity) of the second WLAN device if the at least one of the LL traffic stream windows overlaps with the second WLAN device's TXOP; and
transmitting, by the first WLAN device, the LL traffic during the TXOP of the second WLAN device that was pre-empted.

2. The method of claim 1:
wherein the first WLAN device is an AP and the second WLAN device is a non-AP STA (station).

3. The method of claim 1:
wherein the low latency (LL) traffic stream is created using a stream classification service (SCS) procedure that includes exchanging an SCS request frame and an SCS response frame.

4. The method of claim 3:
wherein the SCS procedure includes a quality of service characteristics element.

5. The method of claim 3:
wherein the SCS request frame or the SCS response frame includes at least one of: an indication of preemption operation, a SCSID, a TID, or LL traffic transmission direction information.

6. The method of claim 3:
wherein either the first or second WLAN devices are only allowed to transmit LL traffic associated with a particular TID or a particular SCSID.

7. The method of claim 3:
wherein the SCS request frame and/or the SCS response frame includes at least one of: a maximum length of a PPDU in the LL traffic; a maximum preemption duration within the TXOP; a periodicity of the the LL traffic stream windows; or a R-TWT SP overriding indication of whether or not preemption is allowed during an R-TWT service period.

8. The method of claim 1:
wherein the low latency (LL) traffic stream schedule is periodic or aperiodic.

9. The method of claim 2:
wherein the low latency (LL) traffic stream includes uplink (UL) traffic sent by the non-AP STA to the AP, downlink (DL) traffic sent by the AP to the non-AP STA, or direct link traffic sent between the non-AP STA and another non-AP STA.

10. The method of claim 2, further comprising:
allocating a non-random access resource unit (non-RA-RU) to the non-AP STA using a trigger frame;
wherein the non-RA-RU enables the non-AP STA to transmit UL traffic.

11. The method of claim 2, further comprising:
allocating a time period to the non-AP STA using a multi-user (MU) request-to-send (RTS) TXOP sharing (TXS) trigger frame;
wherein the MU-RTS-TXS trigger frame enables the non-AP STA to transmit UL traffic or direct-link traffic.

12. The method of claim 2:
further comprising, preempting, by the AP, the TXOP of the non-AP STA during a target wake time service period (TWT SP).

13. The method of claim 12:
wherein the TWT SP may be either an individual TWT SP, a broadcast TWT SP, or a R-TWT SP.

14. The method of claim 12:
wherein pre-empting the TXOP is enabled by giving a higher scheduling priority to the low latency (LL) traffic transmissions, than to TWT requesting STAs transmissions or TWT scheduled STAs transmissions during the TWT SP.

15. The method of claim 12:
wherein the TXOP holder preemption during the TWT SP may be enabled or disabled as part of a negotiated TWT agreement established between a TWT requesting STA (or a TWT scheduled STA) and a TWT responding STA (or a TWT scheduling AP).

16. The method of claim 12:
wherein the TXOP holder preemption during the TWT SP may alternatively be enabled or disabled when a TWT scheduling AP announces TWT SP scheduling information.

17. The method of claim 2, further comprising:
announcing, by the AP, a TXOP preemption time period information in a broadcast management or action frame.

18. The method of claim 17:
wherein the announcement informs various non-AP STAs that a set of LL traffic pre-emption time periods have been defined; and
wherein the announcement informs the various non-AP STAs that any non-AP STA holding a TXOP during a time overlapping any one of these time periods may have their traffic pre-empted.

19. The method of claim 17:
wherein the AP transmits the announcement in either a broadcast management frame, an action frame, or a beacon frame.

20. The method of claim 2, further comprising:
receiving, by the AP from the non-AP STA, an RTS (request to send) frame;
transmitting, by the AP to the non-AP STA, a TXOP preemption request frame instead of a CTS (clear to send) frame;
wherein the TXOP preemption request frame blocks the non-AP STA from obtaining the TXOP; and
scheduling, by the AP, transmission of the LL traffic.

21. The method of claim 2:
wherein the TXOP preemption functionality is indicated in a UHR operation or a UHR capabilities element during an association procedure between the WLAN devices.

22. The method of claim 21:
wherein the UHR element includes bits indicating the WLAN device's LL traffic pre-emption capability and whether permission to use such capability has been granted.

23. The method of claim 2:
wherein the AP grants permission to the non-AP STA to transmit the LL traffic within a TXOP not held by the non-AP STA; and
wherein the non-AP STA is neither a current TXOP holder nor a current TXOP responder.

24. The method of claim 2:
wherein the AP is granted permission to transmit the LL traffic as a current TXOP responder and the AP is not a current TXOP holder.

25. A WLAN (wireless local area network) access point (AP) device, comprising:
a controller configured to,
schedule a set of low latency (LL) traffic stream windows with a non-AP STA (station); and
pre-empt a TXOP (transmission opportunity) of the non-AP STA for LL traffic uplink (UL), downlink (DL), or direct-link transmission during at least one of the LL traffic stream windows, if the at least one of the LL traffic stream windows overlaps with the non-AP STA's TXOP.

26. The method of claim 2:
wherein the AP activates the TXOP preemption functionality after transmitting or receiving a frame indicating TXOP preemption activation.

27. The method of claim 26:
wherein the frame indicating TXOP preemption activation is at least one of a separate control frame or an action frame.

28. The method of claim 26:
wherein the frame indicating TXOP preemption activation is a QoS null frame including an UHR variant HT control field.

29. The method of claim 2:
wherein the AP activates the TXOP preemption functionality in response to the non-AP STA transmitting a request frame for activation of the TXOP preemption functionality.
